(19) United States
(12) Patent Application Publication
(10) Pub. No.: US 2026/0061706 A1
(43) Pub. Date: Mar. 5, 2026

(54) PRINT HEAD AND METHOD FOR ADDITIVE MANUFACTURING SYSTEM

(71) Applicant: Continuous Composites Inc., Coeur d'Alene, ID (US)

(72) Inventors: Jeffrey J WYRICK, Dalton Gardens, ID (US); Chase Bosman, Post Falls, ID (US); Andrew John Overby, Coeur d'Alene, ID (US); Sam Armstrong, Coeur d'Alene, ID (US); Samuel VanDenBerg, Hayden, ID (US); Ryan C. Stockett, Spokane, WA (US)

(73) Assignee: Continuous Composites Inc., Coeur d'Alene, ID (US)

(21) Appl. No.: 19/312,029

(22) Filed: Aug. 27, 2025

Related U.S. Application Data
(60) Provisional application No. 63/688,215, filed on Aug. 28, 2024.

(51) Int. Cl. B29C 64/393; B29C 64/118; B29C 64/209; B29C 64/321; B33Y 10/00; B33Y 40/00; B33Y 50/02

(52) U.S. Cl. CPC B29C 64/393; B29C 64/118; B29C 64/209; B29C 64/321; B33Y 10/00; B33Y 40/00; B33Y 50/02

(57) ABSTRACT

A method is disclosed of additively manufacturing an object. The method may include discharging a material from a supply through an outlet of a print head onto an underlying layer to form the object. The method may also include moving the print head with a support during the discharging, and selectively twisting the material about a longitudinal axis of the material.

### RELATED APPLICATION

This application is based on and claims the benefit of priority from U.S. Provisional Application No. 63/688,215 that was filed on Aug. 28, 2024, the contents of which are expressly incorporated herein by reference.

### TECHNICAL FIELD

The present disclosure relates generally to a manufacturing system and, more particularly, to a print head and method for an additive manufacturing system.

### BACKGROUND

Continuous fiber 3D printing (a.k.a., CF3D®) involves the use of continuous fibers embedded within material discharging from a moveable print head. A matrix is supplied to the print head and discharged (e.g., extruded and/or pultruded) along with one or more continuous fibers also passing through the same print head at the same time. The matrix can be a traditional thermoplastic, a liquid thermoset (e.g., an energy-curable, single- or multi-part resin), or a combination of any of these and other known matrixes. Upon exiting the print head, a cure enhancer (e.g., a UV light, a laser, an ultrasonic emitter, a temperature regulating device, a catalyst supply, or another energy source) is activated to initiate, enhance, and/or complete curing (e.g., cross-linking and/or hardening) of the matrix. This curing occurs almost immediately, allowing for unsupported structures to be fabricated in free space. When fibers, particularly continuous fibers, are embedded within the structure, a strength of the structure can be multiplied beyond the matrix-dependent strength. An example of this technology is disclosed in U.S. Pat. No. 9,511,543 that issued to TYLER on Dec. 6, 2016, which is expressly incorporated herein by reference.

Although CF3D provides for increased strength, compared to manufacturing processes that do not utilize continuous fiber reinforcement, care should be taken to ensure proper steering and compaction of the matrix-coated fibers during and after discharge. Exemplary print heads that provide for at least some of these functions are disclosed in U.S. Pat. No. 11,904,534 that issued on Feb. 20, 2024 (“the '534 patent”), in U.S. Pat. No. 11,465,348 that was granted on Oct. 11, 2022 (“the '348 patent”), and in U.S. Patent Application Publication 2023/0073782 that was published on Mar. 9, 2023 (“the '782 publication”), all of which are expressly incorporated herein by reference.

It has been discovered by the inventors of this subject matter that material discharged by existing print heads can build up to different heights within the same layer, depending on a geometry of the structure being fabricated. For example, layers of material that overlap at radiused areas (e.g., curves and corners) may build up faster than at areas requiring the material to be discharged along straighter trajectories. This is because the continuous reinforcements inside of the composite material being discharged has a generally rectangular cross-section after discharge. The rectangular cross-section lays down flat against an underlying surface along a straight trajectory. However, when the desired trajectory curves within a plane of the layer, reinforcements located at an outer radius of the curve are pulled inward toward a center of the curve and pile up on top of reinforcements at an inner radius of the curve. This buildup, in addition to affecting layer height, can also result in an increased number of voids within the radiused areas. In some situations, the inward pulling can also cause the material to be dislodged from an underlying surface. These effects can be problematic in some applications.

The disclosed print heads, methods and systems are directed at addressing one or more of these issues and/or other problems of the prior art.

### SUMMARY

In one aspect, the present disclosure is directed to a system for additively manufacturing an object. The system may include a support, and a print head operatively connected to and moveable by the support. The print head may include a first module configured to hold a supply of material, and an outlet configured to discharge the material during movement caused by the support. The system may also include a second module located downstream of the first module and upstream of the outlet relative to movement of the material through the print head, the second module configured to selectively twist the material about a longitudinal axis of the material.

In another aspect, the present disclosure is directed to method of additively manufacturing an object. The method may include discharging a material from a supply through an outlet of a print head onto an underlying layer to form the object. The method may also include moving the print head with a support during the discharging, and selectively twisting the material about a longitudinal axis of the material.

### BRIEF DESCRIPTION OF THE DRAWINGS

FIG. 1 is a diagrammatic illustration of an exemplary disclosed additive manufacturing system;

FIG. 2 is a diagrammatic illustration of an exemplary disclosed print head that may be used in conjunction with the system of FIG. 1;

FIG. 3 is a diagrammatic illustration of an exemplary disclosed module that may be used in conjunction with the print head of FIG. 2;

FIG. 4 is a diagrammatic illustration of an exemplary disclosed structure that can be fabricated using the system of FIG. 1 and the print head of FIG. 2;

FIG. 5 includes diagrammatic illustrations of exemplary materials that may be used in conjunction with the system of FIG. 1 and the print head of FIG. 2; and

FIG. 6 includes a diagrammatic illustration of another exemplary disclosed module that may be used in conjunction with the print head of FIG. 2.

### DETAILED DESCRIPTION

The terms “about” and/or “generally” as used herein serve to reasonably encompass or describe minor variations in numerical values measured by instrumental analysis or as a result of sample handling. Such minor variations may be considered to be “within engineering tolerances” and in the order of plus or minus 0% to 10%, plus or minus 0% to 5%, or plus or minus 0% to 1%, of the numerical values.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

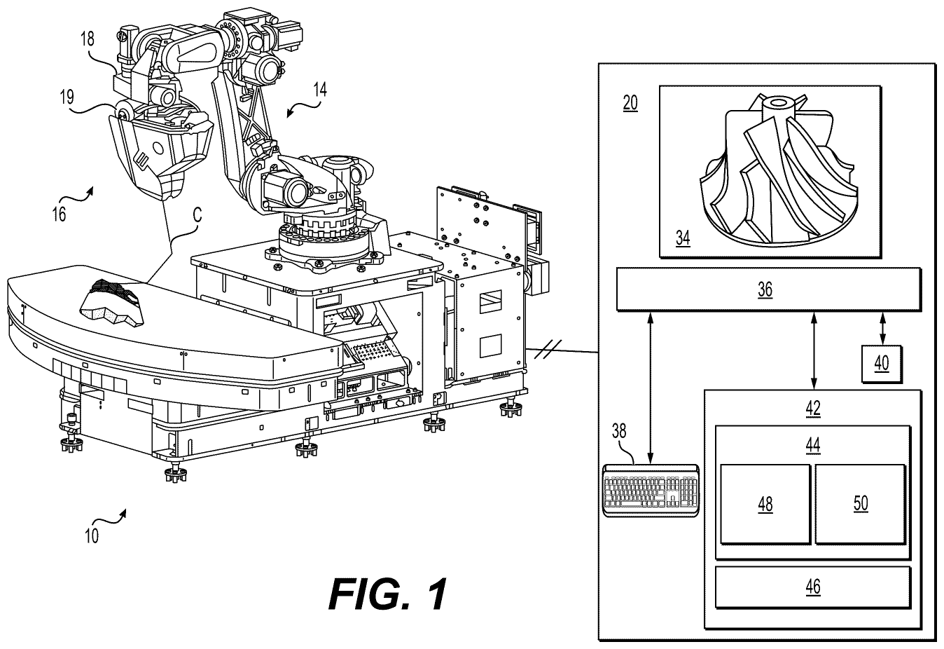

FIG. 1 illustrates an exemplary system 10, which may be used to manufacture a composite structure 12 having any desired shape, size, configuration, and/or material composition. System 10 may include at least a support 14 and a print head (“head”) 16. Head 16 may be coupled to and moveable by support 14 during discharge of a composite material (shown as C). In the disclosed embodiment of FIG. 1, support 14 is a robotic arm capable of moving head 16 in multiple dimensions during fabrication of structure 12. Support 14 may alternatively embody a gantry (e.g., a floor gantry, an overhead or bridge gantry, a single-post gantry, etc.) or a hybrid gantry/arm also capable of moving head 16 in multiple dimensions during fabrication of structure 12. Although support 14 is shown as being capable of 6-axis movements, it is contemplated that another type of support 14 capable of moving head 16 (and/or other tooling relative to head 16) in the same or a different manner could also be utilized. In some embodiments, a drive or coupler 18 may mechanically join head 16 to support 14 and include components that cooperate to move portions of and/or supply power and/or materials to head 16.

Head 16 may be configured to receive or otherwise contain a matrix that, together with a continuous reinforcement (e.g., with or without other additives or fillers), makes up the composite material C discharging from head 16. The matrix may include any type of material that is curable (e.g., a liquid resin, such as a zero-volatile organic compound resin, a powdered metal, etc.). Exemplary resins include thermosets, single- or multi-part epoxy resins, polyester resins, cationic epoxies, acrylated epoxies, urethanes, esters, thermoplastics, photopolymers, polyepoxides, thiols, alkenes, thiol-enes, and more. In one embodiment, the matrix inside head 16 may be pressurized, for example by an external device (e.g., by an extruder or another type of pump—not shown) that is fluidly connected to head 16 via a corresponding conduit (not shown). In another embodiment, however, the pressure may be generated completely inside of head 16 by a similar type of device (discussed in more detail below). In yet other embodiments, the matrix may be gravity-fed into and/or through head 16. For example, the matrix may be fed into head 16 and pushed or pulled out of head 16 along with one or more continuous reinforcements. In some instances, the matrix inside head 16 may benefit from being kept cool, dark, and/or pressurized (e.g., to inhibit premature curing or otherwise obtain a desired rate of curing after discharge). In other instances, the matrix may need to be kept warm and/or light for similar reasons. In either situation, head 16 may be specially configured (e.g., insulated, temperature-controlled, shielded, etc.) to provide for these needs.

The matrix may be used to coat any number of continuous reinforcements (e.g., separate fibers, tows, rovings, ribbons, socks, sheets and/or tapes of continuous material) and, together with the reinforcements, make up a portion (e.g., a wall) of composite structure 12. The reinforcements may be stored within (e.g., on one or more separate internal creels 19) or otherwise passed through head 16 (e.g., fed from one or more external spools—not shown). When multiple reinforcements are simultaneously used, the reinforcements may be of the same material composition and have the same sizing and cross-sectional shape (e.g., circular, square, rectangular, etc.), or of a different material composition with different sizing and/or cross-sectional shapes. The reinforcements may include, for example, carbon fibers, vegetable fibers, wood fibers, mineral fibers, glass fibers, metallic wires, optical tubes, etc. It should be noted that the term “reinforcement” is meant to encompass both structural and non-structural types of continuous materials that are at least partially encased in the matrix discharging from head 16.

The reinforcements may be exposed to (e.g., at least partially coated with) the matrix while the reinforcements are inside head 16, while the reinforcements are being passed to head 16, and/or while the reinforcements are discharging from head 16. The matrix, dry reinforcements, and/or reinforcements that are already exposed to the matrix (e.g., pre-impregnated reinforcements) may be transported into head 16 in any manner apparent to one skilled in the art. In some embodiments, a filler material (e.g., chopped fibers, particles, nanotubes, etc.) may be mixed with the matrix before and/or after the matrix coats the continuous reinforcements.

As will be explained in more detail below, one or more cure enhancers (e.g., a UV light, an ultrasonic emitter, a laser, a heater, a catalyst dispenser, a chiller or fan, and/or another source of cure energy) may be mounted proximate (e.g., within, on, or adjacent) head 16 and configured to enhance a cure rate and/or quality of the matrix as it discharges from head 16. The cure enhancer(s) may be controlled to selectively expose portions of structure 12 to the cure energy (e.g., to UV light, electromagnetic radiation, vibrations, thermal changes, a chemical catalyst, etc.) during material discharge and the formation of structure 12. The cure energy may trigger a chemical reaction to occur within the matrix, increase a rate of the chemical reaction, sinter the matrix, harden the matrix, cause the matrix to change state, or otherwise cause the matrix to cure as it discharges from head 16. The amount of energy produced by the cure enhancer(s) may be sufficient to cure the matrix before structure 12 axially grows more than a predetermined length away from head 16. In one embodiment, structure 12 is at least partially cured before the axial growth length becomes equal to a cross-sectional dimension of the matrix-coated reinforcement.

The matrix and/or reinforcement may be discharged from head 16 via one or more different modes of operation. In a first exemplary mode of operation, the matrix and/or reinforcement are extruded (e.g., pushed under pressure and/or mechanical force) from head 16 as head 16 is moved by support 14 to create the 3-dimensional trajectory within a longitudinal axis of the discharging material. In a second exemplary mode of operation, at least the reinforcement is pulled from head 16, such that a tensile stress is created in the reinforcement during discharge. In this mode of operation, the matrix may cling to the reinforcement and thereby also be pulled from head 16 along with the reinforcement, and/or the matrix may be discharged from head 16 under pressure along with the pulled reinforcement. In the second mode of operation, where the reinforcement is pulled from head 16, the resulting tension in the reinforcement may increase a strength of structure 12 (e.g., by aligning the reinforcements, inhibiting buckling, disbursing loading, etc.), while also allowing for a greater length of unsupported structure 12 to have a straighter trajectory. That is, the tension in the reinforcement remaining after curing of the matrix may act against the force of gravity (e.g., directly and/or indirectly by creating moments that oppose gravity) to provide support for structure 12.

The reinforcement may be pulled from head 16 as a result of head 16 being moved by support 14 away from an anchor (e.g., a print bed, a table, a floor, a wall, an existing surface of structure 12, etc.). For example, at the start of structure formation, a length of matrix-impregnated reinforcement may be pulled and/or pushed from head 16, deposited against the anchor, and at least partially cured, such that the discharged material adheres (or is otherwise coupled) to the anchor. Thereafter, head 16 may be moved away from the anchor (e.g., via controlled regulation of support 14), and the relative movement may cause the reinforcement to be pulled from head 16. It should be noted that the movement of reinforcement through head 16 could be assisted (e.g., via one or more internal feed mechanisms), if desired. However, the discharge rate of reinforcement from head 16 may primarily be the result of relative movement between head 16 and the anchor, such that tension is created within the reinforcement. It is contemplated that the anchor could be moved away from head 16 instead of or in addition to head 16 being moved away from the anchor.

Any number of separate computing devices 20 may be used to design and/or control placement of the composite material within structure 12 and/or to analyze performance characteristics of structure 12 before, during, and/or after formation. Computing device 20 may include, among other things, a display 34, one or more processors 36, any number of input/output (“I/O”) devices 38, any number of peripherals 40, and one or more memories 42 for storing programs 44 and data 46. Programs 44 may include, for example, any number of design and/or printing apps 48 and an operating system 50.

Display 34 of computing device 20 may include a liquid crystal display (LCD), a light emitting diode (LED) screen, an organic light emitting diode (OLED) screen, and/or another known display device. Display 34 may be used for presentation of data under the control of processor 36.

Processor 36 may be a single or multi-core processor configured with virtual processing technologies and use logic to simultaneously execute and control any number of operations. Processor 36 may be configured to implement virtual machine or other known technologies to execute, control, run, manipulate, and store any number of software modules, applications, programs, etc. In addition, in some embodiments, processor 36 may include one or more specialized hardware, software, and/or firmware modules (not shown) specially configured with particular circuitry, instructions, algorithms, and/or data to perform functions of the disclosed methods. It is appreciated that other types of processor arrangements could be implemented that provide for the capabilities disclosed herein.

Memory 42 can be a volatile or non-volatile, magnetic, semiconductor, tape, optical, removable, non-removable, or other type of storage device or tangible and/or non-transitory computer-readable medium that stores one or more executable programs 44, such as analysis and/or printing apps 48 and operating system 50. Common forms of non-transitory media include, for example, a flash drive, a flexible disk, a hard disk, a solid state drive, magnetic tape or other magnetic data storage medium, a CD-ROM or other optical data storage medium, any physical medium with patterns of holes, a RAM, a PROM, an EPROM, a FLASH-EPROM or other flash memory, NVRAM, a cache, a register or other memory chip or cartridge, and networked versions of the same.

Memory 42 may store instructions that enable processor 36 to execute one or more applications, such as design and/or fabrication apps 48, operating system 50, and any other type of application or software known to be available on computer systems. Alternatively or additionally, the instructions, application programs, etc. can be stored in an internal and/or external database (e.g., a cloud storage system—not shown) that is in direct communication with computing device 20, such as one or more databases or memories accessible via one or more networks (not shown). Memory 42 can include one or more memory devices that store data and instructions used to perform one or more features of the disclosed embodiments. Memory 42 can also include any combination of one or more databases controlled by memory controller devices (e.g., servers, etc.) or software, such as document management systems, Microsoft SQL databases, SharePoint databases, Oracle™ databases, Sybase™ databases, or other relational databases.

In some embodiments, computing device 20 is communicatively connected to one or more remote memory devices (e.g., remote databases—not shown) through a network (not shown). The remote memory devices can be configured to store information that computing device 20 can access and/or manage. By way of example, the remote memory devices could be document management systems, Microsoft SQL database, SharePoint databases, Oracle databases, Sybase databases, Cassandra, HBase, or other relational or non-relational databases or regular files. Systems and methods consistent with disclosed embodiments, however, are not limited to separate databases or even to the use of a database.

Programs 44 may include one or more software or firmware modules causing processor 36 to perform one or more functions of the disclosed embodiments. Moreover, processor 36 can execute one or more programs located remotely from computing device 20. For example, computing device 20 can access one or more remote programs that, when executed, perform functions related to disclosed embodiments. In some embodiments, program(s) 44 stored in memory 42 and executed by processor 36 can include one or more of design, fabrication, and/or analysis apps 48 and operating system 50. Apps 48 may cause processor 36 to perform one or more functions of the disclosed methods.

Operating system 50 may perform known operating system functions when executed by one or more processors such as processor 36. By way of example, operating system 50 may include Microsoft Windows, Unix, Linux, OSX, IOS, Raspberry Pi OS (e.g., Rapbian), Android, or another type of operating system 50. Accordingly, disclosed embodiments can operate and function with computer systems running any type of operating system 50.

I/O devices 38 may include one or more interfaces for receiving signals or input from a user and/or system 10, and for providing signals or output to system 10 (e.g., to support 14 and/or head 16) that allow structure 12 to be printed. For example, computing device 20 can include interface components for interfacing with one or more input devices, such as one or more keyboards, mouse devices, and the like, which enable computing device 20 to receive input from a user.

Peripheral device(s) 40 may be standalone devices or devices that are embedded within or otherwise associated with system 10 and used during fabrication of structure 12. Example peripherals can include input devices (e.g., one or more sensors, such as tension sensors, position sensors, pressure sensors, temperature sensors, proximity sensors, level sensors, rotary encoders, scanners, potentiometers, and other sensors known in the art) and/or output devices (e.g., one or more actuators, such as a matrix supply, a reinforcement (e.g., fiber) supply, a heater, a pump, cure enhancer 22, a positioning motor, a cutter, a feed roller, a tensioner, a wetting mechanism, a compactor, etc.). In some embodiments, peripheral device(s) 40 may, themselves, include one or more processors (e.g., a programmable logic control (PLC), a computer numeric controller (CNC), etc.), a memory, and/or a transceiver. When peripheral device(s) 40 are equipped with a dedicated processor and memory, the dedicated processor may be configured to execute instructions stored on the memory to receive commands from processor 36 associated with video, audio, other sensory data, control data, location data, etc., including capture commands, processing commands, motion commands, and/or transmission commands. The transceiver may include a wired or wireless communication device capable of transmitting data to or from one or more other components in system 10. In some embodiments, the transceiver can receive data from processor 36, including instructions for sensor and/or actuator activation and for the transmission of data via the transceiver. In response to the received instructions, the transceiver can packetize and transmit data between processor 36 and the other components.

Design, fabrication, and/or analysis apps 48 may cause computing device 20 to perform methods related to generating, receiving, processing, analyzing, storing, and/or transmitting data in association with operation of system 10 and corresponding design/fabrication/analysis of structure 12. For example, apps 48 may be able to configure computing device 20 to perform operations including: displaying a graphical user interface (GUI) on display 34 for receiving design/control instructions and information from the operator of system 10; capturing sensory data associated with system 10 (e.g., via peripherals 40A); receiving instructions via I/O devices 38 and/or the user interface regarding specifications, desired characteristics, and/or desired performance of structure 12; processing the control instructions; generating one or more possible designs of and/or plans for fabricating structure 12; analyzing and/or optimizing the designs and/or plans; providing recommendations of one or more designs and/or plans; controlling system 10 to fabricate a recommended and/or selected design via a recommended and/or selected plan; analyzing the fabrication; and/or providing feedback and adjustments to system 10 for improving future fabrications.

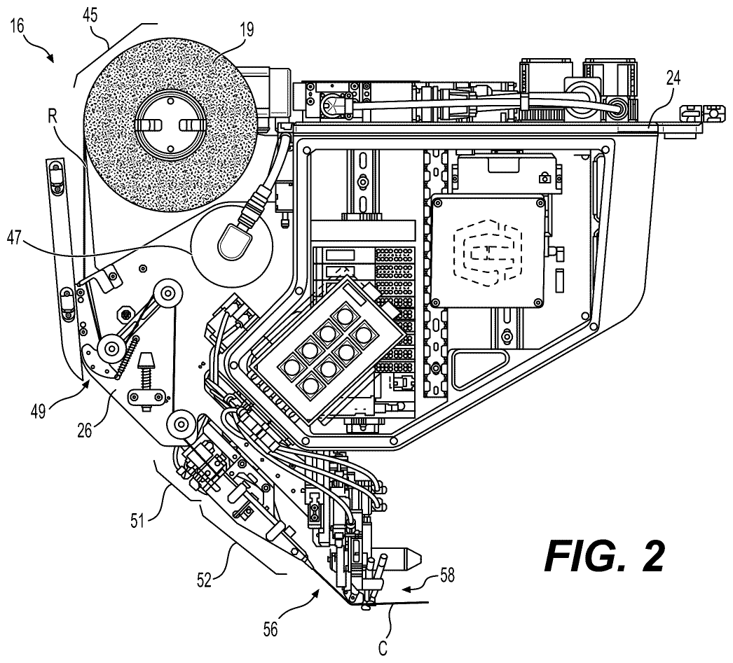

An example head 16 is disclosed in greater detail in FIG. 2. As can be seen in this figure, head 16 may include a mounting arrangement that is configured to hold, enclose, contain, and/or otherwise provide mounting for the remaining components of head 16. The mounting arrangement may include, among other things, an upper generally horizontal plate 24 (e.g., upper as viewed from the perspective of FIG. 2) and one or more generally vertical plates 26 (e.g., lower plates) that intersect orthogonally with upper plate 24. The other components of head 16 may be mounted to a front and/or back of lower plate(s) 26 and/or to a top or bottom side of upper plate 24. As will be explained in more detail below, some components may extend downward past a terminal end of lower plate(s) 26. Likewise, some components may extend transversely from lower plate(s) 26 past outer edges of upper plate 24.

Upper plate 24 may be generally rectangular (e.g., square), while lower plate 26 may be elongated and/or tapered to have a triangular shape. Lower plate 26 may have a wider proximal end rigidly connected to a general center of upper plate 24 and a narrower distal end that is cantilevered from the proximal end. Coupler 18 may be connected to upper plate 24 at a side opposite lower plate(s) 26 and used to quickly and releasably connect head 16 to support 14. Onc or more racking mechanisms (e.g., handles, hooks, eyes, etc.—not shown) may be located adjacent coupler 18 and used to rack head 16 (e.g., during tool changing) when head 16 is not connected to support 14.

Any number of components of head 16 may be mounted to lower plate 26. For example, a reinforcement supply module 45, a matrix supply module 47, a tensioning module 49, a clamping module 51, a wetting module 52, a cutting module 56, and a compacting/curing module 58 may be operatively mounted to lower plate 26. It should be noted that other mounting arrangements may also be possible. Head 16 is disclosed in detail in the '782 publication.

As explained in the '782 publication, the reinforcement may pay out from module 45 (from a spool mounted to creel 19), pass through and be tension-regulated by module 49, and thereafter be wetted with matrix in and discharged through module 52 (e.g., as supplied by module 47). After discharge, the matrix-wetted reinforcement may be selectively severed via module 56 (e.g., while being held stationary by module 51) and thereafter compacted and/or cured by module 58.

The spool of reinforcement may be provided by a manufacturer in multiple different forms. For example, the reinforcement may be provided as a tow of fibers (e.g., many thousands of fibers) that are braided, twisted, or left untwisted before being loaded onto the spool. The inventors of this subject matter have determined that, in some embodiments, untwisted tows are inexpensive, easy to infiltrate with resin (e.g., within module 52), carry high tensile loads with low elongation (e.g., stretching), lie flatter within structure 12 during fabrication via system 10, produce composites with lower porosity, and/or have improved bonding with adjacent layers during compaction and exposure to cure energy from module 58.

Untwisted fiber tow has a generally rectangular cross-section (e.g., a cross-section with a primary or width dimension and a secondary or thickness dimension that is generally orthogonal to the primary dimension, wherein the width dimension is greater than the thickness dimension). In some embodiments, the various modules of head 16 introduced above may be configured to maintain the generally rectangular cross-section of the tow as the tow passes through each module and is discharged onto structure 12 (and/or onto an underlying surface). For example, the portions of module 49 (e.g., various pulleys, rollers, redirects, etc.) that contact the primary flat surfaces of the fiber tow may have a flat inner annular surface and generally perpendicular end flanges that contact the secondary side surface, thereby complementing the rectangular shape of untwisted tow. Similarly, module 51 may include spaced-apart parallel pressure surfaces that engage the primary flat sides of the rectangular shape. Likewise, module 58 may include one or more pressure surface(s) that are generally parallel to the primary flat surfaces of the tow and an underlying surface. It is contemplated that even module 52 may include features (e.g., nozzles having rectangular openings) that help to maintain the desired shape of the tow. Because some or all of the modules of head 16 may be configured to maintain the generally rectangular cross-sectional shape of untwisted fiber tows, structure 12 may have greater performance and appearance, at a lower cost.

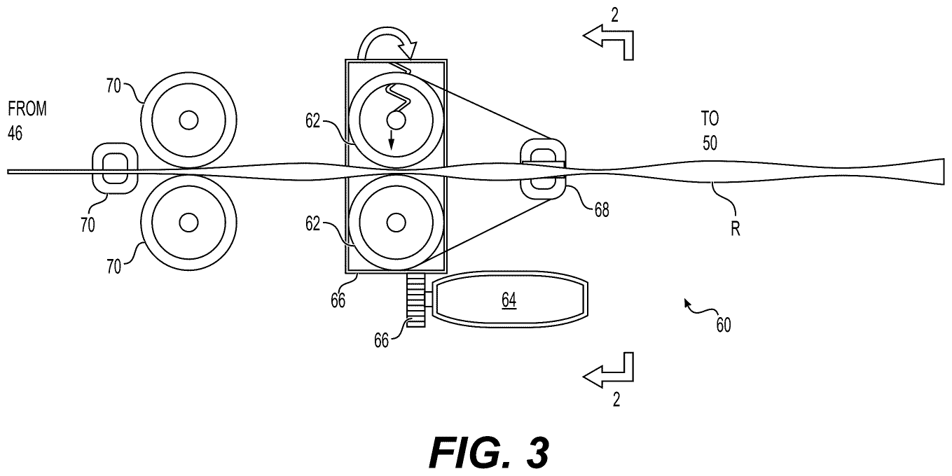

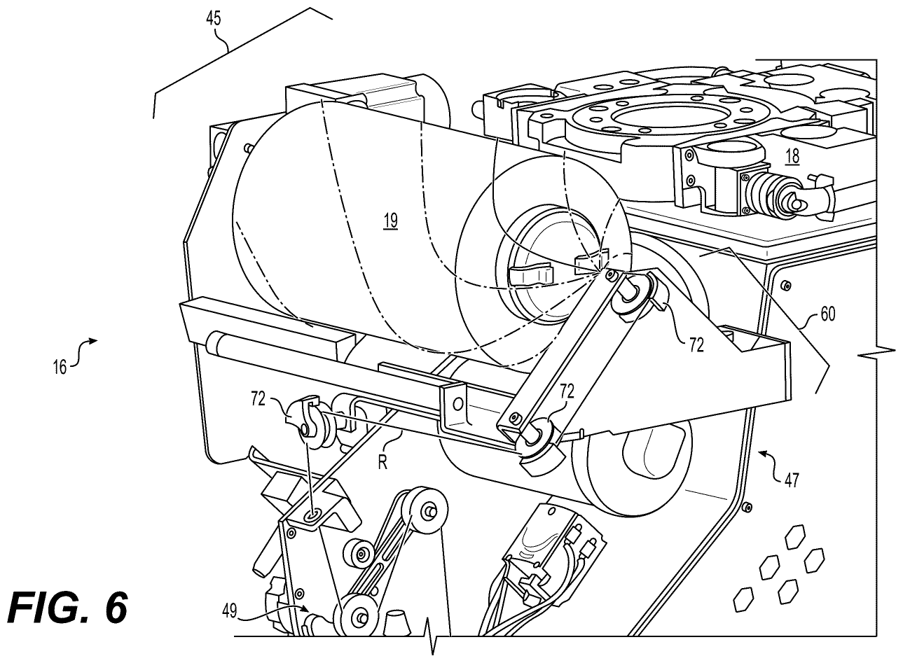

However, as discussed in the Background Section above, Applicant has discovered that discharge of a rectangular tow around a radiused trajectory can be problematic. For this reason, head 16 may be equipped with a twisting module 60 (shown in FIG. 3) configured to selectively twist the tow about a lengthwise center, axis, and/or trajectory of the tow. Module 60 may be placed at any location along the trajectory of the tow passing through head 16 (referring to FIG. 2). In one embodiment, module 60 is placed upstream (i.e., upstream relative to the flow of reinforcement through head 16) of wetting module 52, such that module 60 handles only dry reinforcements (i.e., so that module 60 is not contaminated with matrix). In some embodiments, module 60 is also placed upstream of module 51, such that operation of module 60 does not interfere with clamping of the reinforcements. Although these embodiments describe module 60 as being placed downstream of module 49, other locations for module 60 may also be possible (e.g., see FIG. 6).

An example module 60 is shown in FIG. 3. In this example, module 60 may include at least one guiding mechanism 62, and an actuator 64 configured to impart rotation to mechanism 62. In the specific embodiment of FIG. 3, mechanism 62 includes spaced-apart rollers, between which the tow of reinforcement fibers may pass. The rollers may be urged towards each other (e.g., by a spring), such that the rollers grip and hold the reinforcement fibers. In one application, the rollers of mechanism 62 are free-spinning, allowing pulling and/or pushing of the reinforcement fibers through the rollers via other means. In another application, one or both rollers of mechanism 62 are driven to urge the reinforcement fibers through mechanism 62. In either of these embodiments, actuator 64 may be a motor (e.g., an electric motor, a hydraulic motor, a pneumatic motor, etc.) regulated by computing device 20 to selectively impart rotations of guiding mechanism 62 (e.g., directly or indirectly via a gear train, a pulley, a belt, a chain, a shaft, or another similar mechanism) and the associated reinforcement fibers at a rate and/or in an amount that improves placement of the reinforcement fibers within the curving trajectory of structure 12.

In some applications, an additional guide 68 may be located downstream of the above-described rollers. In these applications, the additional guide 68 may be an eyelet or other non-rolling device that helps to keep the tow of reinforcement fibers centered axially within the rollers. The additional guide 68 may rotate together with the rollers, if desired.

In some applications, one or more non-rotating guides (e.g., eyelets, rollers, nozzles, etc.) 70 may also form part of module 60 and be located upstream of mechanism 62. These guides 70 may function to inhibit or limit an amount of twisting within the reinforcement fibers that propagates upstream of module 60. That is, the reinforcement fibers may be delivered to module 60 without significant twisting occurring before the tow enters module 60, even when actuator 64 is actively twisting the tow.

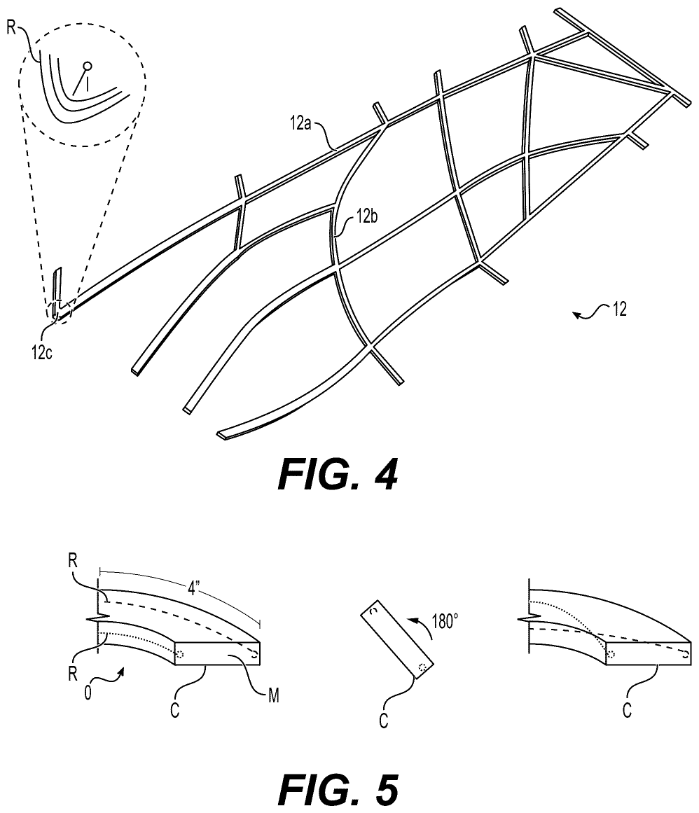

FIGS. 4 and 5 show examples of a structure 12 that may be fabricated using system 10 of FIGS. 1-3. At least some of structures 12 in these examples are manufactured using the matrix M and continuous reinforcement R, which are together considered the composite material C described above. FIGS. 4 and 5 will be discussed in more detail below.

FIG. 6 illustrates an alternative module 60 located at a different position (i.e., different relative to the embodiment of FIG. 3) within head 16 to selectively impart twisting to the reinforcement R. It should be noted that, in the embodiment of FIG. 2, the reinforcement R is generally dispensed from creel 19 in a radial or tangential direction (i.e., a directional generally orthogonal to an axis of creel 19). In this configuration, the reinforcement is unspooled without the unspooling action significantly affecting twisting of the reinforcement. In addition, reinforcement will not unspool in this configuration unless creel 19 is rotating in the unspooling direction. In contrast, in the arrangement of FIG. 6, the reinforcement is generally dispensed in an axial direction. That is, the reinforcement is pulled in a direction generally aligned with the axis of creel 19. During this time, the reinforcement may unspool from creel 19 with or without creel 19 rotating. In fact, as will be described in more detail below, creel 19 may be selectively rotated in a specific direction to affect a resulting twist rate of the reinforcement.

In the configuration of FIG. 6, module 60 may be a generally static assembly. For example, module 60 may include one or more redirects (e.g., eyelets, pulleys, rollers, etc.) 72 located at an end of creel 19. The first of these redirects 72 contacted by the reinforcement from creel 19 may be located concentric with creel 19 and in general alignment with the axis of creel 19. In this manner, the reinforcement may discharge from the end of creel 19 at a substantially constant inward angle toward the axis, regardless of the radial location from which the reinforcement is unspooling (illustrated via dashed lines on creel 19). One or more brackets 74 may connect redirect(s) 72 to one or both of plates 24, 26 (referring to FIG. 2). In embodiments where redirect(s) 72 are pulleys or rollers, axes of these redirect(s) 72 may be oriented generally orthogonal to the axis of creel 19.

In a first example, redirect(s) 72, after having received the reinforcements from the end of creel 19, may redirect the reinforcements to module 49 for tensioning of the reinforcement (i.e., module 60 may be located between modules 45 and 49). In a second example, module 49 may be omitted and/or bypassed (i.e., redirect(s) 72 may redirect the reinforcements to module 51). In this latter embodiment, a different type of tensioning module (e.g., a module without a lever arm that may or may not affect rotation of creel 19) may be utilized in connection with module 60, if desired.

Using the embodiment of module 60 shown in FIG. 6, the reinforcement may be pulled off the end of creel 19 with or without any rotation of the spool. This pulling action, as discussed above, may result from head 16 moving away from an anchor (e.g., a build surface, structure 12, etc.) after a tail end of the reinforcement has been adhered to the anchor. When creel 19 is stationary during the pulling, the reinforcement may twist at a first rate. When creel 19 is rotated in a direction that would tend to unspool the reinforcement at the time of pulling, the twist rate may be reduced by an amount proportional to the rotational rate. When creel 19 is rotated in a direction that would tend to spool up the reinforcement at the time of pulling, the twist rate may be increased by an amount proportional to the rotational rate.

### INDUSTRIAL APPLICABILITY

The disclosed system and print head may be used to manufacture composite structures having any desired cross-sectional size, shape, length, density, and/or strength. The composite structures may include any number of different reinforcements of the same or different types, diameters, shapes, configurations, and consists, each coated with a common matrix. Operation of system 10 will now be described in detail with reference to FIGS. 1-5.

At a start of a manufacturing event, information regarding a desired structure 12 may be loaded into system 10 (e.g., into computing device 20 that is responsible for regulating operations of support 14 and/or head 16—referring to FIG. 1). This information may include, among other things, a size (e.g., diameter, wall thickness, length, etc.), a shape, a contour (e.g., a trajectory), surface features (e.g., ridge size, location, thickness, length; flange size, location, thickness, length; etc.) and finishes, connection geometry (e.g., locations and sizes of couplers, tees, splices, etc.), location-specific matrix stipulations, location-specific reinforcement stipulations, compaction requirements, curing requirements, pressure settings, viscosities, flowrates, etc. It should be noted that this information may alternatively or additionally be loaded into system 10 at different times and/or continuously during the manufacturing event, if desired.

Based on the component information, one or more different reinforcements and/or matrixes may be selectively loaded into head 16. For example, one or more supplies of reinforcement may be loaded onto creel 19 (referring to FIG. 2) of module 45, and one or more cartridges of matrix may be placed into module 47.

The reinforcements may then be threaded through head 16 prior to start of the manufacturing event. Threading may include passing the reinforcement from module 45 around portions of module 49, through the guides and/or between the rollers 62, 68, 70, 72 of module 60 (e.g., before or after threading around module 49—depending on the embodiment), and then through module 51. The reinforcement may thereafter be threaded through module 52 and wetted with matrix. Module 52 may move to an extended position to place the wetted reinforcement under module 58. Module 58 may then be extended to press the wetted reinforcement against an underlying layer. After threading is complete, head 16 may be ready to discharge matrix-coated reinforcements.

Computing device 20 may regulate head 16 to implement a feeding routine. During the feeding routine, modules 51 and 52 may together push a wetted tail of material extending from a nozzle tip of module 52 at least partially under module 58. Module 58 may then be translated to engage the tail (e.g., translated downward in the perspective of FIG. 2). A pressure may be applied to the material by module 58, while module 58 simultaneously exposes the material to cure energy. This may function to anchor the tail.

Once anchoring is complete, module 51 may be deactivated to release the reinforcement, and head 16 may be moved away from the point of anchor to cause the reinforcement to be pulled out of head 16, and then compacted and cured by module 58. This discharge may continue until a target path has been completes and/or until head 16 must move to another location of discharge without discharging material during the move.

The component information may be used to control operations of system 10. For example, the reinforcements may be discharged from head 16 (along with the matrix), while support 14 selectively moves head 16 in a desired manner during curing, such that an axis of the discharging material follows a desired trajectory (e.g., a supported or unsupported, 3-D trajectory) along the target path and forms structure 12. Once material has been placed along the target path(s) associated with structure 12, the material may be selectively severed from head 16 via module 56.

An example structure 12 is illustrated in FIG. 4. In this example, structure 12 provides internal mechanical support for a section (e.g., a wing) of an aircraft. Particularly, structure 12 comprises a number of normally separate support members (e.g., struts, ribs, etc.) that are, in this embodiment, integrally formed via system 10. The support members may be integrally formed via selective splicing, overlapping, and/or continuations of fibers through joints and intersections between the members. Example joints and intersections are disclosed in U.S. Pat. No. 12,128,607 that issued on Oct. 29, 2024, the contents of which are expressly incorporated herein by reference.

During fabrication of structure 12, the composite material discharged by system 10 may be deposited into adjacent (e.g., overlapping) layers. Within each layer, the composite material is discharged into adjacent paths, wherein a thickness of an individual path is substantially identical to a thickness of the corresponding layer in which the path is deposited, at any given location within the layer. Each layer may have the same or a different thickness. It should be noted that each layer making up structure 12 may be planar or non-planar and fully supported by an adjacent layer or extend partially into free-space, as desired. Generally, all paths within a given layer are discharged prior to fabrication of an adjacent (e.g., overlapping) layer, although this may not always be so. Similarly, each layer may generally be compacted and at least partially cured by module 58 prior to fabrication of the adjacent layer.

As shown in FIG. 4, structure 12 may include straight sections 12a, curving sections 12b, and/or tight corners 12c, and computing device 20 may be configured to regulate the various modules of head 16 differently during fabrication of these sections. For example, when fabricating straight sections 12a, computing device 20 may control module 60 such that the reinforcement unspooling from module 49 is substantially unaffected (e.g., untwisted) by module 60. This may allow for the tow of reinforcement fibers to maintain a generally rectangular cross-section when passing through the modules of head 16, be spread out and readily wetted with matrix inside module 52, and be pressed flat against an underlying surface or layer by module 58. That is, the primary surfaces of the tow may be placed adjacent underlying and overlapping layers, while the secondary side surfaces may be placed adjacent other tows within the same layer. As a result, greater mechanical properties and aesthetic appearance may be observed within the straight sections 12a, as compared to results that might otherwise be obtained using a twisted tow.

Curving sections 12b may be differentiated from tight corners 12c based at least in part on a comparison of a radius of each section with one or more radius thresholds. For example, when a section radius is non-zero and greater than a threshold radius, the section may be classified as a curving section 12b. When the section radius is non-zero and less than the threshold radius, the section may be classified as a tight corner 12c. In one embodiment, the threshold radius may be about 75 mm.

When fabricating curving sections 12b, computing device 20 may selectively cause module 60 to twist the tow of reinforcement fibers by a desired amount, at a desired rate, and/or in a desired direction. In one embodiment, the twisting of module 60 may be related to the arc length of a particular curving section 12b being fabricated. For example, it may be desirable to impart one-half of a full rotation (e.g., one twist of approximately 180°—see FIG. 5) into the tow within each continuous arc of curving section 12b. This may allow for a fiber initially located at the outer radius of the arc to be relocated to the inner radius of the arc, and vice versa. For example, for a particular curving section 12b having an arc length of four inches, module 60 may be caused to impart twisting at a rate of 45° per inch of tow travel through module 60 (i.e., 180°/4″=45° per inch). Although not shown, one or more encoders or other sensors may be associated with actuator 64, rolling guides 62, and/or redirects 72 to provide feedback to computing device 20 and thereby help regulate and/or confirm a desired twist and/or twist rate of module 60.

When attempting to lay down an untwisted tow of reinforcement fibers around a curve, the fibers at the outer radius may be forced to stretch and extend a greater distance than the reinforcement fibers located at the inner radius. The result is a tendency for the outer fibers to be pulled radially inward and on top of the inner fibers or for the inner fibers to ribbon or fold radially on top of each other, both of which can result in undesired buildup at the inner radius. However, by selectively twisting the tow of fibers within the curve (e.g., by allowing all of the edge-located fibers to be placed at both the inner and outer radii), all of the fibers may extend an equal distance around the curve. This reduces, if not eliminates, the stretching/extension and the associated buildup. It should be noted that fibers located within a center of the tow (e.g., away from the edges of the rectangular shape) may not experience significant shifting in their relative positions during twisting of the tow.

It is contemplated that a full relocation of each fiber from outer radius to inner radius (i.e., a full twist or 180°) may not be necessary to achieve an acceptable amount of flatness and resulting thickness or buildup within curving section 12b. For example, a one-quarter to one-half rotation (e.g., a partial to full twist of 90-180° of the tow) may be acceptable in some instances. It is also contemplated that the twist rate may vary based on the radius of curving section 12b, if desired. For example, a higher rate of twist may be provided for curving sections 12b having a smaller radius and for tight corners 12c.

In some applications, a direction of twist can be important to improving flatness within a curving section. As shown in the example of FIG. 5, computing device 20 may control the twist direction to bring the upper surface of the tow inward toward the radius of the curvature, such that a resulting torque on the tow urges the reinforcement fibers downward against the underlying surface.

After complete discharge of the twisted tow into curving section 12b, a portion of the tow remaining within head 16 at locations downstream of module 60 (e.g., within modules 51 and 52) may be untwisted. That is, any twists generated within the tow downstream of module 60 may have been pulled out of head 16 and placed within the curving section 12b.

However, when the twist is imparted by the embodiment of FIG. 3, the portion of the tow located between rotating guides 62 and stationary guides 70 may be twisted as a byproduct of the twisting step and remain twisted after the step has terminated. Accordingly, in some embodiments, computing device 20 may be configured to selectively untwist the tow (e.g., twist the tow in an opposite direction as previously twisted) and thereby inhibit overtwisting, knotting, fraying, and/or breakage at the upstream location during sequential fabrication of multiple curving sections 12b.

In one embodiment, computing device 20 may be configured to selectively cause module 60 to untwist the tow after each curving section 12b has been fabricated. In a first example, untwisting may be accomplished during a subsequent fabrication event involving the same or a different curving section 12b. This may be done by selecting to next fabricate a curving section 12b having an oppositely oriented radius, by traversing in an opposite direction the same or a different curving section 12b having a radius oriented the same as in the original curving section 12b, or by twisting in the opposite direction regardless of the relationship to the radius (e.g., even if the twist is away from the center of radius). In a second example, untwisting may be possible during a time in which the tow is not attached to structure 12 and not being discharged (e.g., after a severing event by module 56 and prior to start of a new path of material). It may also be possible to untwist the tow over long stretches of fabricating straight section 12a, such that the slow rate of untwisting does not impart significant negative properties to the material. Other untwisting strategies may also be possible.

It should be noted that, depending on the rate of twist imparted into the tow of reinforcement fibers, the tow may be reshaped from generally rectangular to generally circular in cross-section. That is, while the tow from creel 19 to module 60 may remain generally rectangular, the remainder of the unspooled tow may take on the circular shape during twisting. If not accounted for, this circular shape could degrade properties of structure 12 within the curving sections. For example, a greater amount of porosity may exist and/or an interlaminar strength may be reduced.

To mitigate issues associated with discharge of a circular tow, computing device 20 may be configured to adjust other parameters during fabrication of curved section 12b. For example, computing device 20 may cause support 14 to move head 16 slower during fabrication of curved section 12b (e.g., 5%, 10%, 20%, 30%, 40%, 50%, 60%, 70%, 80% or 90% slower). Additionally or alternatively, computing device 20 may cause module 49 to reduce a tension within the tow during fabrication of curved section 12b (e.g., 5%, 10%, 20%, 30%, 40%, 50%, 60%, 70%, 80% or 90% lower tension). Additionally or alternatively, computing device 20 may cause module 58 to expose the tow to a greater amount of cure energy during fabrication of curved section 12b (e.g., 5%, 10%, 20%, 30%, 40%, 50%, 60%, 70%, 80% or 90% greater energy). Additionally or alternatively, computing device 20 may cause module 58 to compact the tow with greater pressure during fabrication of curved section 12b (e.g., 5%, 10%, 20%, 30%, 40%, 50%, 60%, 70%, 80% or 90% greater pressure). It should be noted that the greater pressure applied to the tow during fabrication of curved section 12b may be sufficient to morph the circular cross-section back to or near its generally rectangular shape, in some applications. Accordingly, in these applications, the tow may unspool from creel 19 with a generally rectangular cross-section, pass through module 60 and obtain a generally circular cross-section, then pass under module 58 and return to a final and generally rectangular shape.

Tight corners 12c may be fabricated in similar manner to curving sections 12b, albeit with a greater rate of twist being imparted in some applications. However, this may still be insufficient to obtain an acceptable level of quality. For example, the tensile forces acting on the tow and caused by motion of head 16 away from an anchored portion of the tow (and regulated by module 49) may be great enough to dislodge the tow from a tight corner 12c. That is, the cured adhesive strength of the matrix may be less than the tensile force within a tight corner 12c. In these situations, care may be taken to improve anchoring of the tow at these locations.

The tensile forces acting on the tow within a tight corner 12c may generally be directed radially inward toward a center of curvature (see enlarged portion of FIG. 4). For this reason, in some applications, an order in which the tows are placed within the tight corners 12c may help reduce a likelihood of dislodgement. For example, a first tow placed within a particular tight corner 12c may be placed at an inner-most location closest to the center of curvature. This first tow may be placed with greater caution (e.g., with slower speeds, higher pressures, higher cure energy intensity, and/or lower tension) and result in a radial block for tows that are subsequently placed adjacent the first tow and further from the center of curvature. It is contemplated that, after placement of the first blocking tow, all other tows may be placed under normal conditions. Alternatively, each subsequent tow may be placed with incrementally reduced caution (e.g., with incrementally increased speeds, lower pressures, lower cure energy intensity, and/or higher tension).

In another embodiment, it is contemplated that the selective twisting of the reinforcement tow may be accomplished without the use of module 60. For example, the twisting may be accomplished before the tow is loaded onto creel 19 (referring to FIG. 2). In one specific embodiment, an entire spool of tow may be twisted at a fixed rate corresponding to a tightest corner planned for fabrication by system 10. For example, for a structure 12 having a tightest corner of 0.5 in and an arc angle of 90°, a twist rate of 2.0 twists-per-inch (TPI) may be suitable to cause the tow to be placed with acceptable flatness into the corner. This TPI may allow for a 180° relocation (e.g., full twist) to occur within the arc of the corner. Accordingly, all of the tow to be used in fabricating structure 12 (e.g., even in the straight sections 12a) may be twisted to have the same twist rate of 2.0 TPI. Smaller arc angles for the given radius and/or a larger radius for the given arc angle (i.e., a longer arc length) may require a lower twist rate. It should be noted that this twist rate may be low enough to result in minimal (if any) reduction in quality within straight section 12a.

In another embodiment, the tow may be twisted to different rates along its length, wherein each length has a twist rate corresponding to a feature anticipated to be fabricated with that length. For example, when structure 12 is anticipated to have a straight section 12a with a length of 40 in, followed by a curved section 12b with an arc length of 30 in, followed by a tight corner 12c with an arc length of 10 in, the tow may have a 40 in untwisted segment, followed sequentially by a 30 in segment twisted with a TPI of 0.017 (e.g., 0.5T/30 in=0.017 TPI), followed by a 10 in segment twisted with a TPI of 0.1 (e.g., 1T/10 in=0.1 TPI). This may allow for no twisting of the tow through the straight section 12a, a one-half relocation (e.g., of inside to outside location, and vice versa) within the curved section 12b (e.g., a lower amount of twist within curves having larger radiuses where buildup isn't as prevalent), and a full relocation with the tight corner 12c (a higher amount of twist within curves having smaller radiuses where buildup is more prevalent).

It is contemplated that module 60 could be retained and used together with a spool of twisted tow, if desired. For example, module 60 could be used to selectively untwist the tow during the straight sections 12a. Alternatively or additionally, the tow may be twisted by a first amount less than required to lay down adequately flat, and thereafter module 60 may be used to complete the required twisting. Other combination strategies may also be utilized.

It will be apparent to those skilled in the art that various modifications and variations can be made to the disclosed system, print head and method. Other embodiments will be apparent to those skilled in the art from consideration of the specification and practice of the disclosed system, print head and method. It is intended that the specification and examples be considered as exemplary only, with a true scope being indicated by the following claims and their equivalents.

What is claimed is:

1. A system for additively manufacturing an object, the system comprising:
a support; and
a print head operatively connected to and moveable by the support, the print head including:
a first module configured to hold a supply of material;
an outlet configured to discharge the material during movement caused by the support; and
a second module located downstream of the first module and upstream of the outlet relative to movement of the material through the print head, the second module being configured to selectively twist the material about a longitudinal axis of the material.

2. The system of claim 1, wherein the material includes a tow of continuous reinforcements extending along the longitudinal axis.

3. The system of claim 2, wherein the supply of material includes a spool having the tow of continuous reinforcements wrapped around the spool.

4. The system of claim 3, wherein the second module is configured to pull the tow of continuous reinforcements axially of an end of the spool.

5. The system of claim 4, further including a motor configured to selectively rotate the spool during pulling of the tow of continuous reinforcements to thereby affect a twist rate of the tow.

6. The system of claim 2, further including a tensioning module configured to tension the tow of continuous reinforcements and being located between the first and second modules.

7. The system of claim 2, further including a wetting module located downstream of the second module and configured to apply a matrix to the tow of continuous reinforcements.

8. The system of claim 7, further including a clamping module disposed between the second module and the wetting module and configured to selectively clamp the tow of continuous reinforcements.

9. The system of claim 1, further including a controller in communication with the second module and configured to selectively activate at least one of the second module or a motor associated with the first module based on a path trajectory of the material.

10. The system of claim 9, wherein the controller is programmed to cause the material to twist about the longitudinal axis by an amount corresponding to a curvature of the path trajectory.

11. The system of claim 10, wherein the controller is configured to selectively cause the second module to untwist a portion of the material extending upstream of the second module.

12. The system of claim 10, wherein the controller is programmed to cause the second module to twist the material by about ½ to 1 full twist along a length of curvature in the path trajectory.

13. The system of claim 10, wherein the controller is programmed to cause the second module to twist the material in a direction that brings an outer portion of the material toward an inside of the curvature and presses the material toward an underlying surface.

14. A method of additively manufacturing an object, the method comprising:
discharging a material from a supply through an outlet of a print head onto an underlying layer to form the object;
moving the print head with a support during the discharging; and
selectively twisting the material about a longitudinal axis of the material.

15. The method of claim 14, wherein selectively twisting includes selectively twisting the material at a location inside of the print head before discharging the twisted material.

16. The method of claim 15, wherein selectively twisting includes selectively twisting the material prior to loading the material into the print head for use in the discharging.

17. The method of claim 16, further including determining a curvature having a smallest radius in a trajectory of path of the material to be discharged from the print head, wherein selectively twisting includes selectively twisting the material to have a fixed twist rate along its length that is based on the smallest radius.

18. The method of claim 16, wherein:
discharging the material includes discharging a plurality of segments within a trajectory of a path of the material to be discharged from the print head; and
selectively twisting includes selectively twisting the material to have a plurality of different twist rates along its length corresponding to curvatures of the plurality of segments within the trajectory of the path.

19. The method of claim 14, wherein twisting the material includes twisting the material by an amount corresponding to a curvature in a path trajectory of the material in the object.

20. The method of claim 19, wherein twisting the material includes twisting the material by the amount corresponding to the curvature includes twisting the material by about ½ to 1 full twist along a length of the curvature.
